(19) United States
(12) Patent Application Publication
(10) Pub. No.: US 2024/0323285 A1
(43) Pub. Date: Sep. 26, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Mitsuru SATO, Kanagawa (JP)

(73) Assignee: FUJIFILM Business Innovation Corp., Tokyo (JP)

(21) Appl. No.: 18/454,797

(22) Filed: Aug. 24, 2023

(30) Foreign Application Priority Data
Mar. 23, 2023 (JP) 2023-046326

(51) Int. Cl. H04N 1/00; H04N 1/21

(52) U.S. Cl. CPC H04N 1/00209; H04N 1/0049; H04N 1/21

(57) ABSTRACT

An information processing apparatus includes a processor configured to: acquire time information as information indicating a date and a time of acquisition of image data; transmit information including the date in the acquired time information, the information serving as information indicating a storage location in a storage destination where the image data is stored when the image data is transferred to the storage destination; and transmit information including any date on or after a following day of the date, instead of transmitting the information including the date in the time information, when the image data is transferred if the time in the time information has passed a predetermined time.

### CROSS-REFERENCE TO RELATED APPLICATIONS

This application is based on and claims priority under 35 USC 119 from Japanese Patent Application No. 2023-046326 filed Mar. 23, 2023.

### BACKGROUND

### (i) Technical Field

The present disclosure relates to information processing apparatuses, information processing methods, and non-transitory computer readable media.

### (ii) Related Art

For example, Japanese Unexamined Patent Application Publication No. 2017-135561 discloses a configuration in which, when image data received by a facsimile receiver is to be transferred in accordance with a predetermined condition, a folder serving as a transfer destination is determined by referring to information about the image data, and a folder name of the folder is set as three hierarchical layers including a hierarchical layer of, for example, a date.

### SUMMARY

When the acquired image data is transferred to a storage destination where the image data is stored, and is stored at a storage location corresponding to the acquisition date, it is conceivable that a person-in-charge performs work to complete a process on the stored image data within the current day. If the person-in-charge is to transfer image data acquired after a predetermined time, such as the business end time, to the storage location corresponding to the acquisition date, the image data does not undergo the process on the current day and remains unprocessed. Therefore, when the person-in-charge performs work on the following day and refers only to a storage location corresponding to the date of the following day, there is a possibility in which the image data not processed on the day of acquisition is overlooked and remains unprocessed.

Aspects of non-limiting embodiments of the present disclosure relate to reducing a situation where image data not processed on the day of acquisition is overlooked and remains unprocessed on or after the following day.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to: acquire time information as information indicating a date and a time of acquisition of image data; transmit information including the date in the acquired time information, the information serving as information indicating a storage location in a storage destination where the image data is stored when the image data is transferred to the storage destination; and transmit information including any date on or after a following day of the date, instead of transmitting the information including the date in the time information, when the image data is transferred if the time in the time information has passed a predetermined time.

### BRIEF DESCRIPTION OF THE DRAWINGS

Exemplary embodiments of the present disclosure will be described in detail based on the following figures, wherein:

FIG. 1 illustrates an example of an image management system;

FIG. 2 illustrates a hardware configuration example of an information processing unit provided in an image forming apparatus and an information processing unit provided in a server apparatus;

FIG. 3 is a block diagram illustrating a functional configuration of the image forming apparatus and the server apparatus;

FIG. 4 is a flowchart illustrating a processing example in a central processing unit (CPU) of the information processing unit in the image forming apparatus according to a first exemplary embodiment;

FIG. 5 illustrates a first specific example according to the first exemplary embodiment;

FIGS. 6A and 6B illustrate second specific examples according to the first exemplary embodiment, FIG. 6A illustrating specific example 1 thereof, FIG. 6B illustrating specific example 2 thereof;

FIG. 7 is a flowchart illustrating a processing example in the CPU of the information processing unit of the image forming apparatus according to a second exemplary embodiment; and

FIG. 8 illustrates a specific example according to the second exemplary embodiment.

### DETAILED DESCRIPTION

An exemplary embodiment of the present disclosure will be described below with reference to the drawings.

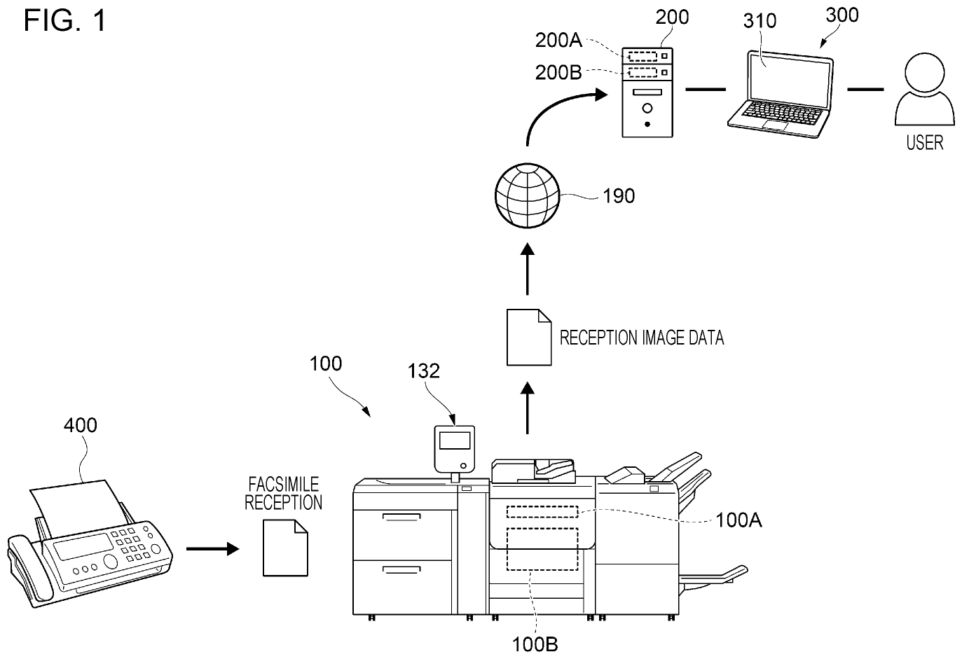

FIG. 1 illustrates an example of an image management system 1.

The image management system 1 according to this exemplary embodiment is provided with an image forming apparatus 100 having various functions, such as a copying function, a printing function, a facsimile function, and a scanning function, and a server apparatus 200 connected to the image forming apparatus 100 by a communication line 190. In this exemplary embodiment, the image forming apparatus 100 as an example of an information processing apparatus manages an image received by facsimile. The image is saved in a confidential box included in the image forming apparatus 100, or is transferred to the server apparatus 200 and is managed by being stored at a corresponding storage location. With regard to the image data, the transfer source is the image forming apparatus 100, and the transfer destination is the server apparatus 200.

Furthermore, the image management system 1 according to this exemplary embodiment is provided with a user terminal 300 that is connectable to the server apparatus 200 and that receives an operation from a user.

Although a single user terminal 300 is displayed in FIG. 1, multiple user terminals 300 may be provided.

The image forming apparatus 100 is provided with an information processing unit 100A. The information processing unit 100A executes various processes with respect to the image forming apparatus 100. For example, when the image forming apparatus 100 receives image data from a facsimile apparatus 400, the image forming apparatus 100 performs a predetermined process.

The image forming apparatus 100 is also provided with a storage device 100B that stores data. The storage device 100B stores data, such as reception image data received by facsimile or print data to be printed, and may be used as a box, such as a confidential box, created by software. The storage device 100B is realized with, for example, a hard disk drive (HDD). The reception image data is an example of image data.

The image forming apparatus 100 is provided with an image forming unit that forms an image on a sheet as an example of a recording medium by using, for example, the inkjet method or the electrophotography method.

The server apparatus 200 is provided with an information processing unit 200A that executes various processes. The information processing unit 200A executes various processes with respect to the server apparatus 200.

The server apparatus 200 is provided with a storage device 200B that stores data. The storage device 200B may include multiple folders for storing data transferred from the image forming apparatus 100. The folders are created based on a command from the user terminal 300 or a creation request from the information processing unit 200A, and are managed.

The storage device 200B is realized with, for example, an HDD.

The user terminal 300 is provided with a display device 310. The display device 310 is capable of displaying data stored in the storage device 200B of the server apparatus 200.

The user terminal 300 is realized with a computer. Examples of the user terminal 300 include a personal computer (PC), a smartphone, and a tablet terminal.

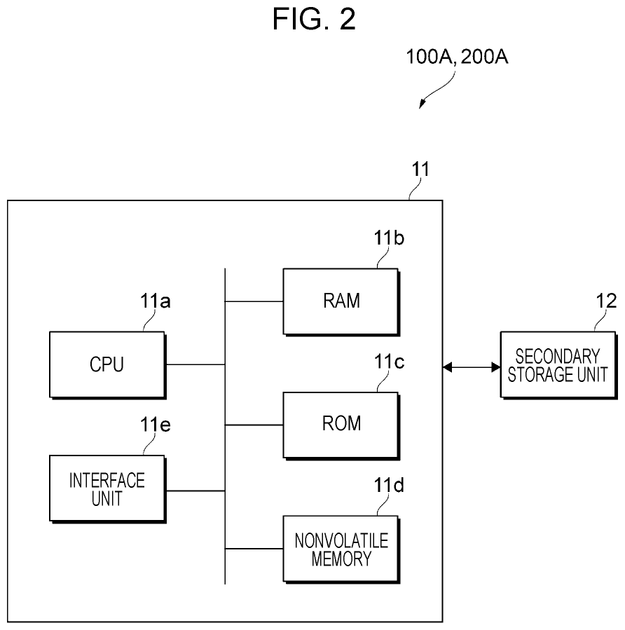

FIG. 2 illustrates a hardware configuration example of the information processing unit 100A provided in the image forming apparatus 100 and the information processing unit 200A provided in the server apparatus 200. Each of the information processing units 100A and 200A is realized with a computer.

Each of the image forming apparatus 100 and the server apparatus 200 has an arithmetic processing unit 11 that executes a digital arithmetic process in accordance with a program, and a secondary storage unit 12 that stores information.

The secondary storage unit 12 is realized with an existing information storage device, such as an HDD, a semiconductor memory, or magnetic tape.

The arithmetic processing unit 11 is provided with a central processing unit (CPU) 11a as an example of a processor.

The arithmetic processing unit 11 is also provided with a random access memory (RAM) 11b used as a working memory for the CPU 11a and a read-only memory (ROM) 11c that stores a program to be executed by the CPU 11a.

The arithmetic processing unit 11 is further provided with a rewritable nonvolatile memory 11d capable of retaining data even when not supplied with electric power, and an interface unit 11e that controls each unit, such as a communication unit, connected to the arithmetic processing unit 11.

The nonvolatile memory 11d is constituted of, for example, a static random access memory (SRAM) or a flash memory backed up by a battery. In addition to a file, the secondary storage unit 12 stores a program to be executed by the arithmetic processing unit 11.

In this exemplary embodiment, the arithmetic processing unit 11 reads the programs stored in the ROM 11c and the secondary storage unit 12 so as to execute various processes. The program to be executed by the CPU 11a may be provided to the information processing units 100A and 200A by being stored in a computer-readable storage medium, such as a magnetic storage medium (e.g., magnetic tape or a magnetic disk), an optical storage medium (e.g., an optical disk), a magneto-optical storage medium, or a semiconductor memory. Alternatively, the program to be executed by the CPU 11a may be provided to the information processing units 100A and 200A by using a communication unit, such as the Internet.

In this description, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

Furthermore, the term “processor” is broad enough to encompass one processor or plural processors in collaboration which are located physically apart from each other but may work cooperatively. The order of operations of the processor is not limited to one described in this exemplary embodiment, and may be changed.

Of processes to be described below, a process to be performed by the image forming apparatus 100 is performed by the CPU 11a as an example of a processor provided in the image forming apparatus 100.

Furthermore, of the processes to be described below, a process to be performed by the server apparatus 200 is performed by the CPU 11a as an example of a processor provided in the server apparatus 200.

An information processing system constituted of the image forming apparatus 100 may be realized with a single apparatus, such as a single image forming apparatus 100, or may be realized with multiple apparatuses.

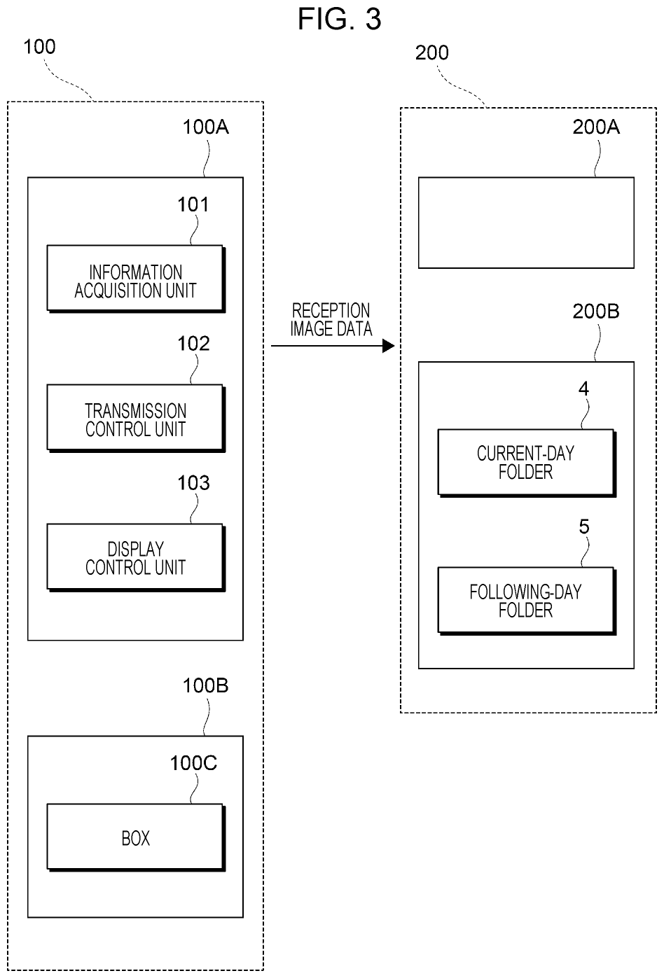

FIG. 3 is a block diagram illustrating a functional configuration of the image forming apparatus 100 and the server apparatus 200.

As shown in FIG. 3, the information processing unit 100A of the image forming apparatus 100 has an information acquisition unit 101, a transmission control unit 102, and a display control unit 103.

The information acquisition unit 101 acquires various types of information, such as the reception image data and information about the reception time. The information acquisition unit 101 performs various processes related to the reception image data by using the acquired information.

The information acquisition unit 101 acquires information from the server apparatus 200 and the user terminal 300.

The transmission control unit 102 performs control for transmitting the various types of information acquired by the information acquisition unit 101 and results of the aforementioned processes to the server apparatus 200.

The display control unit 103 performs display control of the display device 310 of the user terminal 300 with respect to the server apparatus 200. The content of the display control is transmitted to the server apparatus 200 by the transmission control unit 102.

As shown in FIG. 3, the storage device 100B of the image forming apparatus 100 includes a box 100C including the aforementioned confidential box. For example, the reception image data is stored in the box 100C.

The storage device 200B of the server apparatus 200 has multiple folders. The multiple folders are created by the information processing unit 200A in response to a request from the image forming apparatus 100. For example, the multiple folders may include a folder for every date and a folder for every person-in-charge as a user of the user terminal 300.

The storage device 200B has the multiple folders created by the information processing unit 200A. The multiple folders may include a person-in-charge folder as a folder created for every person-in-charge and a date folder as a folder created for every date.

For example, the reception image data (see FIG. 1) is stored in a person-in-charge folder of a person-in-charge assigned in accordance with a predetermined condition. In this case, a date folder may be created in the person-in-charge folder and be used as a date folder for every reception date as the date of facsimile reception. The reception date may conceivably be included as a folder name of the date folder.

As shown in FIG. 3, in this exemplary embodiment, the storage device 200B has a current-day folder 4 and a following-day folder 5 as the multiple folders.

Of the date folders mentioned above, the current-day folder 4 is a date folder of the current day and includes the reception date of the current day with reference to a certain day in a folder name. The following-day folder 5 is a date folder of the following day and includes the reception date of the following day in a folder name.

A folder that includes the reception date of a previous day with reference to a certain day in a folder name may be referred to as a date folder of the previous day.

The person-in-charge who uses the user terminal 300 is responsible for work involving performing a predetermined process with respect to the reception image data (see FIG. 1) stored in the person-in-charge folder. The reception image data assigned to the person-in-charge is stored in the date folder within the person-in-charge folder. Furthermore, the person-in-charge processes the reception image data stored in the date folder of the current day within business hours of the current day.

In the aforementioned work, if reception image data received outside the business hours of the current day is stored in the current-day folder 4, the current-day folder 4 has unprocessed reception image data stored therein. Therefore, if the person-in-charge forgets to check the unprocessed reception image data located in the date folder of the previous day during work on the following day, the unprocessed case is overlooked, so that a prompt process is not performed. Even if the person-in-charge subsequently becomes aware of the unprocessed case and performs a process thereon, the process is unfavorably delayed.

Furthermore, during the work on the following day, if the person-in-charge confirms the unprocessed reception image data in the current-day folder 4 serving as the date folder of the previous day, the person-in-charge may have to perform an operation for moving the unprocessed reception image data to the following-day folder 5, thus resulting in a troublesome task. If there are multiple items of unprocessed reception image data, the operation may have to be performed carefully to prevent operational errors, thus possibly leading to lower working efficiency.

In this exemplary embodiment, reception image data received by facsimile outside the business hours of the current day is stored in the following-day folder 5 instead of the current-day folder 4. Accordingly, during work on the following day, unprocessed reception image data may be prevented from being overlooked without having to check whether there is unprocessed reception image data in the date folder of the previous day. Moreover, the operation for moving the unprocessed reception image data may be omitted, thereby preventing a decrease in working efficiency.

The server apparatus 200 is an example of a storage destination, the current-day folder 4 and the following-day folder 5 in the storage device 200B of the server apparatus 200 are examples of storage locations, and the folder names thereof are examples of information indicating the storage locations.

The following description relates to a first exemplary embodiment and a second exemplary embodiment. First, the first exemplary embodiment will be described. With regard to the second exemplary embodiment, descriptions common to the first exemplary embodiment may sometimes be omitted.

### First Exemplary Embodiment

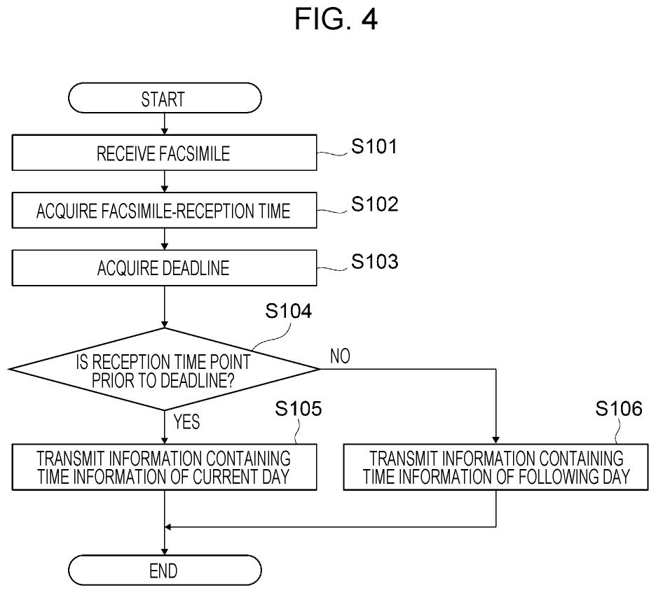

FIG. 4 is a flowchart illustrating a processing example in the CPU 11a (see FIG. 2) of the information processing unit 100A in the image forming apparatus 100 according to the first exemplary embodiment.

In the processing example shown in FIG. 4, if the image forming apparatus 100 receives a facsimile from the facsimile apparatus 400 (see FIG. 1) in step S101, the information acquisition unit 101 (see FIG. 3) of the CPU 11a stores acquired reception image data in the storage device 100B. Then, the information acquisition unit 101 acquires time information of the current day, that is, facsimile-reception time information, serving as information indicating the date and time of the facsimile reception in step S102, and acquires deadline information in step S103.

The deadline information in this case is information input to the image forming apparatus 100 and used for sorting the reception image data in the current-day folder 4 or the following-day folder 5 as a storage location, and is preliminarily stored in the RAM 11b (see FIG. 2) of the information processing unit 100A.

The deadline information may be input to an operation reception unit 132 (see FIG. 1) of the image forming apparatus 100 or may be input to the image forming apparatus 100 via the communication line 190. The deadline is an example of a predetermined time.

In step S104, the information acquisition unit 101 uses the acquired facsimile-reception time information and the acquired deadline information to determine whether a reception time point based on the facsimile-reception time is prior to the deadline.

If the reception time point is prior to the deadline (Yes in step S104), the transmission control unit 102 (see FIG. 3) transmits information containing time information of the current day to the server apparatus 200 in step S105 to set the storage location for the reception image data to be transferred to the current-day folder 4 (see FIG. 3). The information containing the time information transmitted to the server apparatus 200 is, for example, file-path information including a date folder name and a filename indicating a reception time point of reception image data.

In contrast, if the reception time point is after the deadline (No in step S104), the transmission control unit 102 transmits information containing time information of the following day to the server apparatus 200 in step S106 to set the storage location for the reception image data to the following-day folder 5 (see FIG. 3).

The information transmitted in step S105 and step S106 described above may include the content of display control by the display control unit 103 (see FIG. 3).

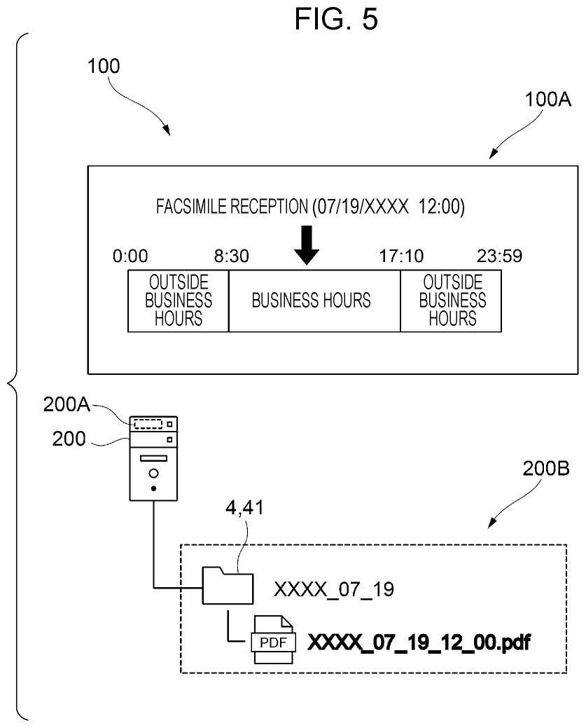

FIG. 5 illustrates a first specific example according to the first exemplary embodiment, and shows a case where facsimile reception occurs within business hours. The business hours are from 8:30 to 17:10 in 24-hour notation, and the deadline is set to 17:10, which is the same as the business end time point. In the first exemplary embodiment, the business end time point and the deadline are set to, but not limited to, the same time point. Alternatively, the deadline may be set to, for example, 17:00 that is prior to the business end time point of 17:10.

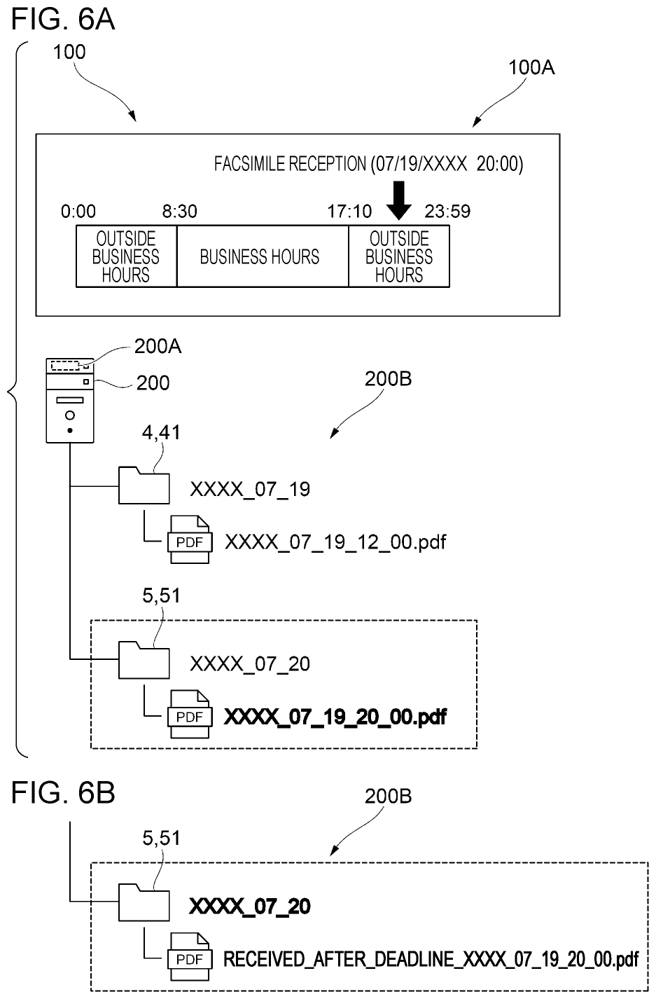

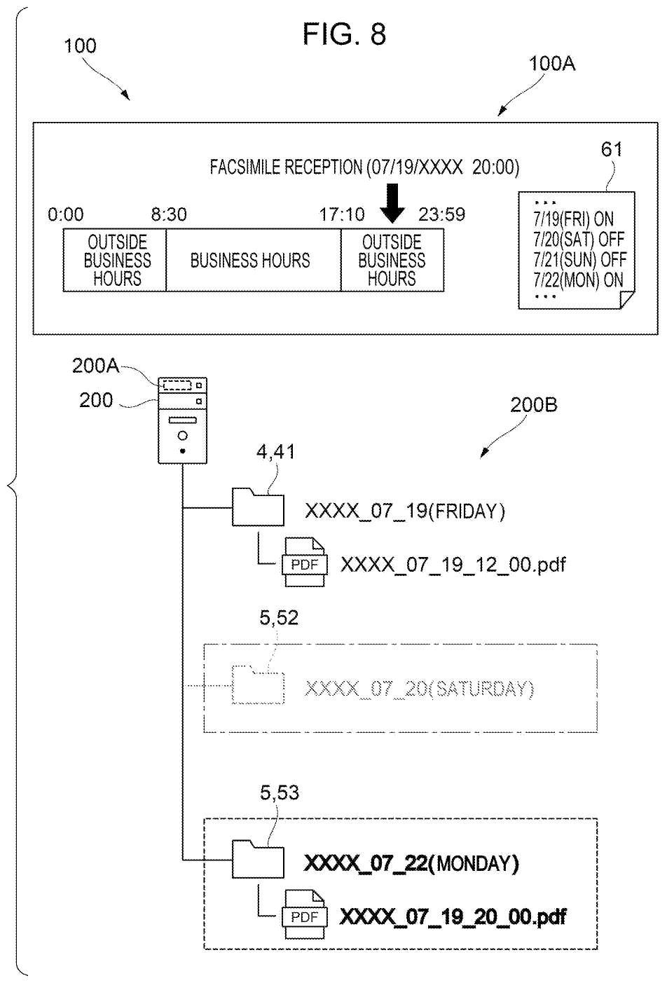

Although FIG. 5 is a diagram for explaining the image forming apparatus 100 and the server apparatus 200, a part indicating the file configuration within the storage device 200B of the server apparatus 200 may be regarded that the part indicates a mode of a screen displayed on the display device 310 (see FIG. 1) of the user terminal 300 from a different perspective. The same applies to FIGS. 6A and 6B and FIG. 8.

In the case shown in FIG. 5, the facsimile-reception time in the image forming apparatus 100 indicates 12:00 on July 19, XXXX, meaning that the reception time point is prior to the deadline. Therefore, the transmission control unit 102 (see FIG. 3) transmits information containing time information of the current day to the server apparatus 200 (see step S105 in FIG. 4). As an example of this time information, file-path information “-/XXXX_07_19/XXXX_07_19_12_00.pdf” is transmitted.

As mentioned above, the time information of the current day contains information indicating the date of the current day of facsimile reception and information indicating the time point thereof. As mentioned above, the information containing the time information of the current day includes the content of display control by the display control unit 103.

When the server apparatus 200 receives the information containing the time information of the current day, the information processing unit 200A checks whether the storage device 200B has a first folder 41. A folder name of the first folder 41 is based on information indicating the date of the current day and is “XXXX_07_19”.

If there is no first folder 41, the information processing unit 200A newly creates the first folder 41 as the current-day folder 4 in the storage device 200B. As an alternative to this exemplary embodiment in which a folder existing in the server apparatus 200 is checked on an as-needed basis at the transmission timing of reception image data, a folder existing in the server apparatus 200 may be checked in advance every time a predetermined time elapses.

Furthermore, the information processing unit 200A stores reception image data currently received from the image forming apparatus 100 into the first folder 41 in the storage device 200B by using a filename of a predetermined file format. Specifically, newly acquired reception image data undergoes a file format conversion and a filename change and is stored with a filename “XXXX_07_19_12_00.pdf” in the folder “XXXX_07_19”.

The filename stored in the first folder 41 shown in FIG. 5 is indicated with a bold font. The mode of screen display using this bold font indicates that the file is unprocessed or that the process has not started.

In other words, the rectangle indicated with the dashed line is given for illustrative purposes but may serve as the mode of screen display on the display device 310 of the user terminal 300. The same applies to FIGS. 6A and 6B and FIG. 8 to be described later.

FIGS. 6A and 6B illustrate second specific examples according to the first exemplary embodiment and show a case where facsimile reception occurs outside the business hours. Specifically, FIG. 6A illustrates specific example 1 thereof, and FIG. 6B illustrates specific example 2 thereof.

In the case of specific example 1 shown in FIG. 6A, the facsimile-reception time indicates 20:00 on July 19. XXXX, meaning that the reception time point is not prior to the deadline. Therefore, the transmission control unit 102 (see FIG. 3) transmits information containing time information of the following day to the server apparatus 200 (see step S106 in FIG. 4).

When the server apparatus 200 receives the information containing the time information of the following day, the information processing unit 200A checks whether the storage device 200B has a second folder 51. A folder name of the second folder 51 is based on information indicating the date of the following day and is “XXXX_07_20”.

If there is no second folder 51, the information processing unit 200A newly creates the second folder 51 as the following-day folder 5 in the storage device 200B.

Furthermore, the information processing unit 200A stores reception image data from the image forming apparatus 100 into the second folder 51 in the storage device 200B by using a filename of a predetermined file format. Specifically, newly acquired reception image data undergoes a file format conversion and a filename change and is stored with a filename “XXXX_07_19_20_00.pdf” in the folder “XXXX_07_20”.

In the case shown in FIG. 6A, since a file stored in the first folder 41 has already been processed, the filename thereof is not displayed with a bold font. On the other hand, a filename stored in the second folder 51 is unprocessed and is thus indicated with a bold font.

In specific example 2 shown in FIG. 6B, the filename stored in the second folder 51 is different from that in specific example 1 in FIG. 6A. More specifically, the second folder 51 is an example of the following-day folder 5, and is given a filename that allows the person-in-charge to readily recognize that the reception image data has been received on the previous day.

Specifically, in specific example 2, the filename is given text that reads “received after deadline” at the front thereof, and is “received_after_deadline_XXXX_07_19_20_00.pdf”. Thus, the filename serves as a reminder to the person-in-charge. As a mode alternative to the added text “received_after_deadline”, a text string, such as a predetermined symbol, may be added in addition to the text or in place of the text.

In specific example 2 shown in FIG. 6B, the folder name is different from that in specific example 1 and is indicated with a bold font, so as to serve as a reminder to the person-in-charge together with the filename mentioned above.

As a display mode for such a reminder, the display mode of reception image data received prior to the deadline and the display mode of reception image data received after the deadline may be varied from each other by, for example, varying the display color in addition to changing the folder serving as the storage location, changing the filename, adding a text string to the filename, and using the bold font, as mentioned above.

Next, the second exemplary embodiment will be described.

### Second Exemplary Embodiment

If the date of the following-day folder 5 corresponds to a non-business day instead of a business day of the company to which the person-in-charge belongs, there is a possibility in which an unprocessed case may be overlooked or the working efficiency of the person-in-charge may decrease.

In the second exemplary embodiment, a folder including the date of the next business day or operating day is set as the storage location for the reception image data based on calendar information of the company.

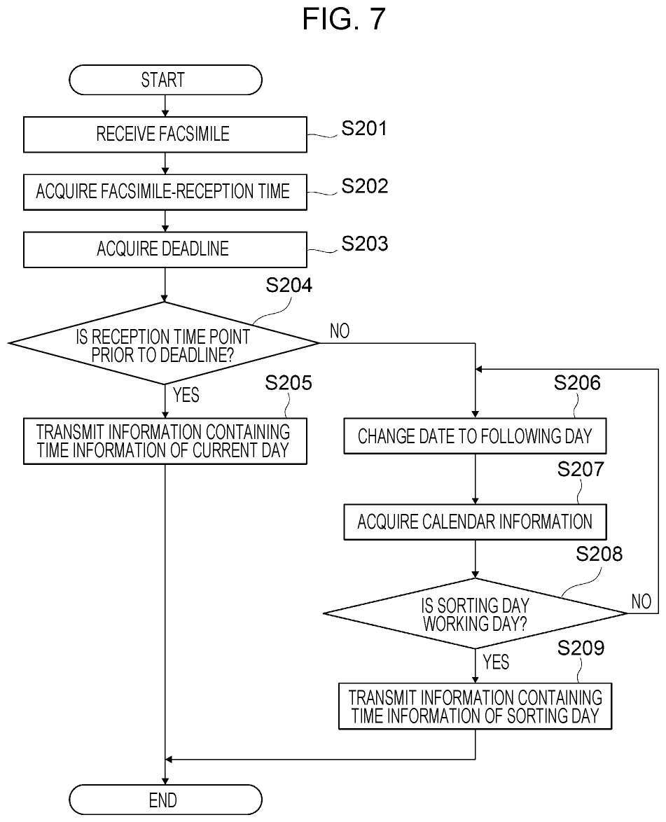

FIG. 7 is a flowchart illustrating a processing example in the CPU 11a (see FIG. 2) of the information processing unit 100A in the image forming apparatus 100 according to the second exemplary embodiment. FIG. 7 corresponds to FIG. 4 used above for describing the first exemplary embodiment. Since step S201 to step S205 in FIG. 7 correspond to step S101 to step S105 in FIG. 4, descriptions thereof will be omitted.

In the processing example shown in FIG. 7, if the reception time point is not prior to the deadline (No in step S204), the information acquisition unit 101 changes the date for setting a sorting destination for new reception image data from the current day to the following day in step S206. In step S207, the information acquisition unit 101 acquires calendar information serving as information indicating at least one of a working day and a non-business day of the company. Then, it is determined in step S208 whether a sorting day as the date for setting the storage location, that is, the sorting destination, is a working day.

If the sorting day is not a working day (No in step S208), a process of returning to step S206 to change the date to the following day and determining in step S208 whether the changed date is a working day is repeated.

If the sorting day is a working day (Yes in step S208), information containing time information of the sorting day is transmitted to the server apparatus 200 in step S209. Accordingly, the image forming apparatus 100 designates a folder including the date of the next working day as the storage location for new reception image data in the server apparatus 200.

The calendar information is used for determining the nearest day on which the reception image data is to be processed, and includes common calendar information indicating public holidays and days of the week, as well as, for example, company calendar information indicating holidays and working days designated by the company. The calendar information may also include personal calendar information indicating scheduled working days and scheduled holidays of the person-in-charge responsible for processing the reception image data. The calendar information used in step S207 may be one or more of the aforementioned types of calendar information.

FIG. 8 illustrates a specific example according to the second exemplary embodiment and shows a case where facsimile reception occurs outside the business hours. FIG. 8 corresponds to FIGS. 6A and 6B used for describing specific example 1 according to the first exemplary embodiment and illustrates a case where facsimile reception occurs outside the business hours, similar to FIGS. 6A and 6B. In FIG. 8, descriptions of sections common to FIGS. 6A and 6B may sometimes be omitted.

In the specific example shown in FIG. 8, the information processing unit 100A of the image forming apparatus 100 includes calendar information 61. In other words, the calendar information 61 is retained in the RAM 11b (FIG. 2) of the information processing unit 100A.

According to the calendar information 61, the current day of July 19 is a working day, whereas the following day of July 20 and the day after the following day, that is, July 21, are non-business days, and the next working day is July 22.

Therefore, the information processing unit 200A stores the reception image data from the image forming apparatus 100 in a folder 53 “XXXX_07_22(Monday)” including the date “07_22(Monday)” of a working day in the folder name thereof. Similar to the case in specific example 1 (see FIG. 6A), the reception image data has a filename “XXXX_07_19_20_00.pdf” indicating the facsimile reception time.

Similar to specific example 2 (see FIG. 6B), the folder name and the filename in the folder 53 are indicated with a bold font.

More specifically, the reception image data is not stored in a folder 52 “XXXX_07_20(Saturday)” including the date “07_20(Saturday)” of a non-business day in the folder name thereof. Accordingly, the folder 52 is not to be used as a storage location for the reception image data and is thus not to be created. Therefore, the folder 52 is displayed lighter than the folder 53 in FIG. 8 and is indicated with a single-dot chain line used for indicating an imaginary object.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An information processing apparatus comprising:
a processor configured to:
   acquire time information as information indicating a date and a time of acquisition of image data;
   transmit information including the date in the acquired time information, the information serving as information indicating a storage location in a storage destination where the image data is stored when the image data is transferred to the storage destination; and
   transmit information including any date on or after a following day of the date, instead of transmitting the information including the date in the time information, when the image data is transferred if the time in the time information has passed a predetermined time.

(((2))) The information processing apparatus according to (((1))),
wherein the any date on or after the following day is set based on calendar information.

(((3))) The information processing apparatus according to (((2))),
wherein the calendar information includes information indicating at least one of a business day and a holiday of a company that processes the image data.

(((4))) The information processing apparatus according to (((2))).
wherein the calendar information includes information indicating at least one of a working day and a holiday of a person-in-charge who processes the image data.

(((5))) The information processing apparatus according to any one of (((1))) to (((4))),
wherein, when the information including the any date on or after the following day of the date is to be transmitted, a command for generating the storage location is given if the storage location in the storage destination corresponding to the any date does not exist.

(((6))) The information processing apparatus according to (((1))) or (((5))).
wherein the image data when the information including the any date on or after the following day of the date is transmitted is displayed in a different mode from the image data when the information including the date in the time information is transmitted.

(((7))) The information processing apparatus according to (((6))),
wherein the different mode includes varying a display color of the image data at the storage location.

(((8))) The information processing apparatus according to (((1))) or (((5))),
wherein the image data when the information including the any date on or after the following day of the date is transmitted includes a filename to which a text string is further added, the text string allowing the information including the any date to be identifiable.

(((9))) A program causing an information processing apparatus to execute a process, the process comprising:
acquiring time information as information indicating a date and a time of acquisition of image data;
transmitting information including the date in the acquired time information, the information serving as information indicating a storage location in a storage destination where the image data is stored when the image data is transferred to the storage destination; and
transmitting information including any date on or after a following day of the date, instead of transmitting the information including the date in the time information, when the image data is transferred if the time in the time information has passed a predetermined time.

What is claimed is:

1. An information processing apparatus comprising:
a processor configured to:
acquire time information as information indicating a date and a time of acquisition of image data;
transmit information including the date in the acquired time information, the information serving as information indicating a storage location in a storage destination where the image data is stored when the image data is transferred to the storage destination; and
transmit information including any date on or after a following day of the date, instead of transmitting the information including the date in the time information, when the image data is transferred if the time in the time information has passed a predetermined time.

2. The information processing apparatus according to claim 1,
wherein the any date on or after the following day is set based on calendar information.

3. The information processing apparatus according to claim 2,
wherein the calendar information includes information indicating at least one of a business day and a holiday of a company that processes the image data.

4. The information processing apparatus according to claim 2,
wherein the calendar information includes information indicating at least one of a working day and a holiday of a person-in-charge who processes the image data.

5. The information processing apparatus according to claim 1,
wherein, when the information including the any date on or after the following day of the date is to be transmitted, a command for generating the storage location is given if the storage location in the storage destination corresponding to the any date does not exist.

6. The information processing apparatus according to claim 1,
wherein the image data when the information including the any date on or after the following day of the date is transmitted is displayed in a different mode from the image data when the information including the date in the time information is transmitted.

7. The information processing apparatus according to claim 6,
wherein the different mode includes varying a display color of the image data at the storage location.

8. The information processing apparatus according to claim 1,
wherein the image data when the information including the any date on or after the following day of the date is transmitted includes a filename to which a text string is further added, the text string allowing the information including the any date to be identifiable.

9. A non-transitory computer readable medium storing a program causing an information processing apparatus to execute a process, the process comprising:
acquiring time information as information indicating a date and a time of acquisition of image data;
transmitting information including the date in the acquired time information, the information serving as information indicating a storage location in a storage destination where the image data is stored when the image data is transferred to the storage destination; and
transmitting information including any date on or after a following day of the date, instead of transmitting the information including the date in the time information, when the image data is transferred if the time in the time information has passed a predetermined time.

10. An information processing method comprising:
acquiring time information as information indicating a date and a time of acquisition of image data;
transmitting information including the date in the acquired time information, the information serving as information indicating a storage location in a storage destination where the image data is stored when the image data is transferred to the storage destination; and
transmitting information including any date on or after a following day of the date, instead of transmitting the information including the date in the time information, when the image data is transferred if the time in the time information has passed a predetermined time.
